(19) United States
(12) Patent Application Publication
(10) Pub. No.: US 2008/0167079 A1
(43) Pub. Date: Jul. 10, 2008

(54) WINNER NOTIFICATION SYSTEM

(76) Inventors: Brook W. Garrettson, El Dorado Hills, CA (US); Garrett A. Garrettson, Pebble Beach, CA (US); Kevin B. Larkin, Pebble Beach, CA (US)

Correspondence Address: Brook W. Garrettson, PO Box 157, Pebble Beach, CA, 93953, US

(21) Appl. No.: 11/621,115

(22) Filed: Jan. 9, 2007

(51) Int. Cl. H04B 1/38

(52) U.S. Cl. 455/566

(57) ABSTRACT

The present invention allows a purchaser or client to download proprietary software onto a mobile and/or handheld device for a nominal fee. This software enables the device to read information automatically from one or more tickets or entry receipts for a random drawing or other lottery-style game. Facilitated by the downloaded software, the read information is transmitted to a third-party service where it is stored, compared and verified to determine if there exists one or more matches with winning number(s). Alternatively, winning number, game and consumer, subscriber and/or client verification credentials can be transmitted or broadcasted to an enabled mobile and/or handheld device on a periodic or on-demand basis such that a given verification and notification transaction is then carried out and concluded autonomously at the mobile and/or handheld device without the need for on-demand interaction with a central or third-party database and/or verification service. The individual consumer or client is then notified (via interactive message, text message, email, telephone or mail) of the outcome of the comparison. The individual consumer or client may be charged for services rendered for each comparison, verification and/or notification.

### CROSS-REFERENCE TO RELATED APPLICATIONS

This application claims benefit and priority of provisional application No. 60/758,324, filed on Jan. 11, 2006.

### FIELD OF THE INVENTION

This invention relates to lottery or gaming tickets.

### BACKGROUND OF THE INVENTION

Lottery games such as the California Mega-Lotto and Mega-Millions are played such that an individual or group may purchase a ticket with one or more play number(s) generated as part of the document record at a time prior to the selection of winning number(s) by the game authority. A winning number is always generated on a date that is after play number(s) are generated. The purchaser(s) must therefore retain their play number(s) and/or ticket(s), until their corresponding winning play number selection has occurred, before verification of the play number(s) against the corresponding winning number(s) is possible.

To verify whether or not a play number is a winning number, the individual or group assignees of a purchased play number(s) must then verify their play number(s) against the official winning number(s) available through the California Lottery via internet website, newspaper, or television broadcast. Alternatively, the purchaser(s) may verify the winning status of a play number(s) by scanning the bar-coded ticket(s) at a lottery or gaming retailer (gas station, convenience store, etc.).

The current method of lottery or gaming participation requires a minimum of three separate actions, one to purchase, one to wait while retaining play number(s) until the corresponding winning number(s) have been selected by the lottery or gaming authority, and one to verify if the play number(s) is a/are winning number(s). Obvious problems include the loss, theft or destruction of printed play number(s) from the time they are purchased, acquired and/or issued until the time of corresponding winning play number(s) selection and verification. We propose a marketable alternative to automatically address the verification phase in a manner that could allow for virtual duplication of one or more lottery tickets or entry receipts and associate them with at least one corresponding participant.

The proposed application is an added convenience for lottery or game players and is expected to broaden the market appeal of such games. As it aims to eliminate the worries associated with erroneous manual number comparison, time spent searching for published or broadcast winning numbers and the insecurity of relying upon the honesty and efficiency of those present at a lottery or gaming retailer when winning numbers are verified. Individuals playing a lottery or game who must purchase their play number(s) in advance of winning number selection may rest assured that their purchased play number(s) will be duplicated into a database (heretofore meant to include “mainframe” in all tenses) and automatically verified, notifying the playing individual or group whether or not they have winning play number(s). The duplicated play number information may stored centrally or at the mobile and/or handheld device.

U.S. Pat. No. 6,760,476 “Method of Checking Lottery Numbers,” Jul. 6, 2004 is prior art that addresses a method for checking lottery ticket numbers for winning matches via character image processing and recognition. Our method is not limited to the scope of data transfer capability, the location of transaction or the necessity of point-of-demand communication with a central database as demonstrated within in the prior art. Our method is further unique in that we propose taking advantage of the convenience and capabilities of commonly and readily available mobile or handheld devices with an established and defined method of payment transaction; devices that are uniquely enabled using a proprietary software and unique method of download such that they may complete transactions and services autonomously without requiring point-of-demand communication with a centralized database.

### SUMMARY OF THE INVENTION

The present invention is designed to allow consumers (lottery or gaming ticket buyers) or clients (e.g. lottery or gaming retailer or communications service providers) to download proprietary software onto a mobile and/or handheld device for a nominal fee thus enabling the device to read information automatically from one or more tickets or entry receipts for a lottery, pool, raffle, random drawing or other game/event involving officiated determination of winner(s) via discriminatory selection of an individual entry or entries. (Selected winning number(s) or coordinate(s) may or may not correspond to actual assigned play number or coordinate assigned to an individual or group for a particular event or draw.) Facilitated by the downloaded software, the read information is transmitted to a third-party service where it is stored and verified (heretofore meant to include “compared” in all tenses) to determine if there is one or more matches with winning number(s). Alternatively, winning number, game and consumer, subscriber and/or client verification credentials may be transmitted or broadcasted to an enabled mobile and/or handheld device on a periodic or on-demand basis such that a given verification and notification transaction is then carried out and concluded autonomously at the mobile and/or handheld device without the need for on-demand interaction with a central or third-party database and/or verification service. The individual consumer or client is then notified of the outcome of the comparison. The individual consumer or client may be charged for services rendered for each comparison, verification and/or notification, for example, via billing to a new or existing cell phone, internet or telephone account.

### BRIEF DESCRIPTION OF THE DRAWINGS

Shown is a system diagram depicting the hardware configuration for use with an embodiment of the present invention.

FIG. 1 depicts a method and system architecture for use with an embodiment of the invention in claims 1 and 2. In this figure, module 1A refers to a cellphone, PC/laptop/PDA or other device equipped with a camera and/or photo and/or image processor in either the consumer or retailer domain; and

FIG. 2 depicts a method for transfer of proprietary software into device (FIG. 1, module 1A) for use with an embodiment of the invention in claim 3.

### REFERENCES CITED

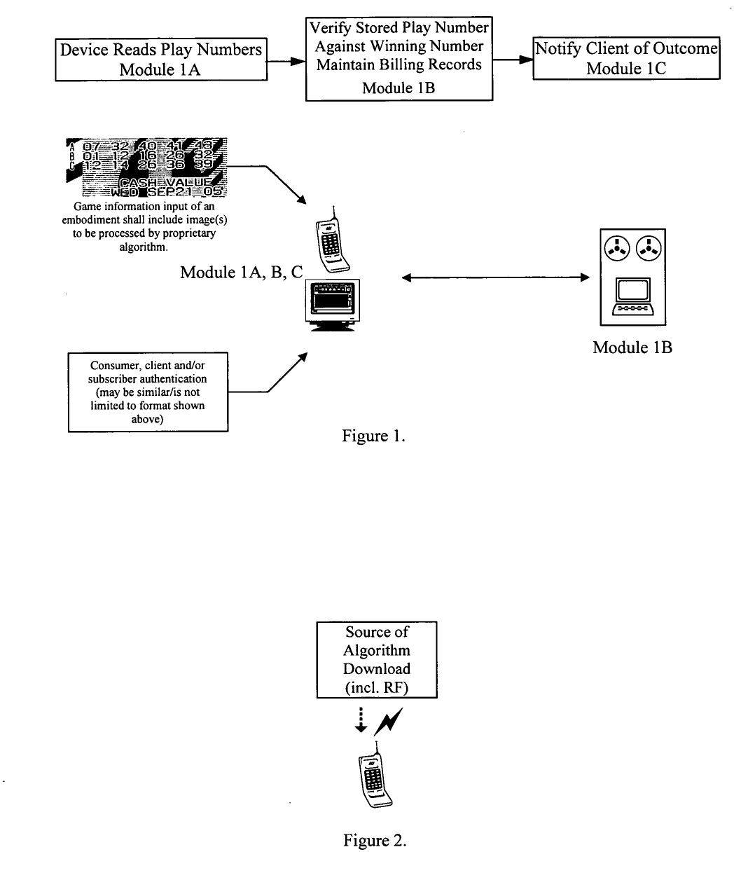

Optical Character Recognition (OCR) or machine-recognition of characters and symbols from an image is well-known in the art as evidenced by FIG. 1, module 1A herein by reference to U.S. Pat. No. 6,357,658, 6,561,428 and 6,199,044 in their entirety. Machine-enabled checking of lottery ticket numbers using OCR is well-known in the art as evidenced by FIG. 1, module 1B herein by reference to U.S. Pat. No. 6,760,476 and 5,417,424 in their entirety.

### DETAILED DESCRIPTION OF THE INVENTION

The proposed application provides automatic notification of the winning status of play numeral(s) and/or letter(s) and/or character(s) (heretofore meant to be included in the terms “number,” “numbers” and “number(s)”) using a mobile or handheld device loaded with proprietary software for a lottery, raffle, pool, game or other event involving officiated determination of winner(s) via discriminatory selection of an individual entry or entries. In the case of the California State Lottery, an embodiment of the present invention offers a convenience to lottery or gaming players as well as privacy as winning play number(s) and ticket(s) are verified without the need to be publicly verified at a lottery or gaming retailer (gas station, convenience store, etc.).

The process of “reading” a ticket or entry receipt (FIG. 1, module 1A) would be performed by a machine or device capable of communication using a variety of protocol and media with the aforementioned third-party verification service (FIG. 1, module 1B). The mobile device of claim 1 is at least one of, or a combination of, entries from the group consisting of a digital/photo image processor or camera, cellphone, mobile phone, smart phone, telephone/videophone, PDA, pager, pocket PC, laptop computer, personal computer, multi-media center, cable television/internet or satellite receiver/terminal allowing data input, radio receiver/transceiver, or optical image processor. The device that communicates with the verification service (FIG. 1, module 1B) may be wireless or non-wireless, such as a cell phone with or without a camera/photo image processor/reader, or other mobile or handheld device capable of digital, analog or voice-enabled data communications with the verification service. Voice recognition capability at the mobile and/or handheld device (FIG. 1, module 1A) and/or at the database (FIG. 1, module 1B) would allow for a consumer, client or subscriber to enter a user name, password and then the lottery or gaming ticket information by an ordinary telephone or cell phone. The verification service would use one or more communication media and protocol to notify the individual consumer or client (FIG. 1, module 1C) including text message, email, internet, wireless device (cell phone, PDA, pager), laptop computer, personal computer, or telephone. The entry or ticket or other assigned play number documentation may be physical (e.g. paper) or electronic in format.

The proprietary software introduced in claim 7 can be transferred to said device (FIG. 1, module 1A-C) at a (game) retail location or other domain (FIG. 2) for a nominal fee using any one or combination of the following protocol: Bluetooth, wireless LAN or WAN, the mobile device service provider's wireless network, device data port or other data transfer protocol (FIG. 2). The software shall facilitate any one or combination of the following: image capture, data input, processing and storage; character, code and signal recognition; communication with a central or third-party database and/or verification service (FIG. 1, module 1B) and/or data transmission/broadcast source to allow the completion of (data) verification and notification transactions in the method of claim 1.

Data transfer including software download and comparison/verification/notification transactions may employ encryption and decryption and may utilize any combination of one or more of the following media: wireless networks, LAN, WAN and internet. The software introduced in claim 7 could be downloaded into the mobile device (FIG. 1, module 1A and 1B) using the aforementioned media and/or over the mobile device service provider wireless network.

Said mobile device (FIG. 1, module 1A) may decipher and/or validate numerals, letters, characters and other machine-readable codes from images or signals collected from any machine-readable surface or item, either passive or active, and may process, decipher, validate and/or recognize information associated to the play number(s) including draw dates, subscriber identification, billing and payment information and other relevant game or event identification. The aforementioned surface may have an image that is physically or electronically-generated with examples that include at least one lottery or gaming ticket, credit/debit account receipt, entry receipt or other record of play number purchase and/or assignment.

Any entered, read and processed data that is stored or transmitted is verified for sufficiency using the proprietary software introduced in claim 7, such as for a valid lottery or gaming play number, draw date, game identification and valid subscriber identification and payment/billing information, prior to completion of the comparison, verification and notification service transaction described in claim 1 (FIG. 1). If a data error or insufficiency is detected by the verification process (FIG. 1, module 1A and/or 1B), the subscriber shall be notified.

Character recognition, information extraction, data comparison and verification could occur entirely at either one or partly at both of the following: 1) the mobile device (FIG. 1, module 1A; or 2) the database (FIG. 1, module 1B).

Further, winning number, game and consumer, subscriber and/or client identification and billing/payment credentials can be transmitted or broadcasted to an enabled mobile and/or handheld device (FIG. 1, module 1A) on a periodic, once-available or on-demand basis such that subscriber identification and play number(s) can be verified dynamically and at the point of service using the proprietary software introduced in claim 7 upon device processing of data that is read or inputted into the device via the methods outlined in claim 4 and/or capture of at least one raw digital picture. The notification transaction is carried out and concluded autonomously on-demand at the mobile and/or handheld device (FIG. 1, module 1A and 1B) without the need for on-demand interaction with a central or third-party database and/or verification service (FIG. 1, module 1B). The initiating device (FIG. 1, module 1A) may therefore be (associated with) the destination device (FIG. 1, module 1C) and may carry out some or all comparison, verification and notification tasks (FIG. 1, module 1B) regarding the winning status of device-read, photo image processed or manually entered play number(s) as well as verification/authentication regarding subscriber identification, payment and billing and error notifications and instructions relevant to completion of a given transaction. Verification may be completed automatically and/or upon manual comparison.

Records of transaction for services rendered may be transmitted or broadcasted to and from said mobile handheld device (FIG. 1, module 1A) and to and from said centralized database or third-party service (FIG. 1, module 1B) on a periodic or on-demand basis for purposes of consumer, subscription and/or client billing and records maintenance.

The individual consumer or client may be charged for proprietary software download to a mobile or handheld device as well as for services rendered for each comparison, verification and/or notification, for example, via billing to a new or existing cell phone, internet or telephone account and/or credit card or prepaid/debit card account.

Charges may be reduced, waived or rebated for certain consumers, subscribers and/or clients under the conditions of a given promotion or marketing campaign active at a given time. One or more subscribers of the said verification service and one or more guests of a verifiable subscriber may use all or limited features of the said service at no charge or for a nominal fee for a limited time duration and/or for a limited number of individual transactions per user. A user/client/subscriber may want to scan a lottery or gaming ticket of a non-user/client/subscriber i.e. an interested friend or acquaintance. If the guest's play number entry is a winner and the guest's identity is intended to be separate from that of the hosting subscriber in the verification system, a surcharge could apply.

A periodic statement of account activity including some or all transaction history that could include game information upload and comparison results would be optionally distributed to consumers, clients or subscribers using one or more means of electronic or non-electronic communication.

The proposed application allows for an eventual merger of the said invention with the operations of various gaming commissions and authorities such that the execution and/or completion and/or conclusion of some or all parts of one or more said comparison, verification and notification transactions may constitute or yield a valid replacement or substitution of one or more separately issued and purchased lottery tickets, play numbers and entry receipts. If one or more valid game tickets, entry receipts, play numbers (with associated game information) that are issued for the first time to one or more consumers, subscribers and/or clients, one or more appropriate lottery and/or gaming commissions and/or authorities shall receive fair payment for game entries that originate from solely the first and/or a combination of the following: 1) the result of the mechanism and/or associated service of the present invention and 2) one or more lottery or gaming authorities or commissions.

The following presents a detailed description of some embodiments of the present invention. However, it should be apparent to one skilled in the art that the described embodiment may be modified in form and content to be optimized for a wide variety of situations.

1. A method, using a mobile and/or handheld device, of entering or reading play number information (e.g. lottery or gaming ticket) and subsequently notifying the subscriber whether the play number is a winning number.

2. The method of claims 1 and 15, wherein the mobile device is enabled by proprietary software in order to read, decipher, store, transmit, and receive digital data that includes the play number, as well as the corresponding winning number from the central or third party processor, database and verification service in order to associate the play number information with the subscriber information, to compare the play number information against corresponding winning number data and to communicate the results to the subscriber via the mobile handheld device.

3. The method of claim 2, wherein the subscriber shall be notified of the winning status of play numbers and the billing status via any electronic means, including text message, telephone call or voicemail, email or fax that may or may not involve the mobile and/or handheld device, as well as by physical mail, telegram or other non-electronic means.

4. The method of claims 2 and 15, wherein the play ticket information, including at least one play number, game/event identification, subscriber identification and billing/payment information, may be entered manually at the user interface (key pad, touch display, dial/touch tone, voice recognition, etc.) of the mobile or handheld device.

5. The method of claims 2 and 15, wherein the user enters a password to enable the mobile device to identify and verify the subscriber identification and to read or access the subscriber billing information in order to validate the transaction or to debit the subscriber account for any charges associated with at least one notification transaction.

6. The method of claim 2, wherein the mobile device is a camera phone or smart phone.

7. The method of claims 2, 6 and 15, wherein the mobile device is enabled by proprietary software to analyze and process the photo image of the physical play ticket/receipt and use character recognition techniques to extract the play number, game identification and other relevant information on the play ticket/receipt.

8. The method of claims 2, 6 and 15, wherein the mobile device stores, captures and transmits picture image data to a central processor (that is part of the verification service) where the picture data is analyzed in order to extract the play number, game identification, subscriber identification, payment and billing information and other relevant information.

9. The method of claims 2 and 15, wherein the mobile or handheld device has the capability of reading and/or deciphering and/or processing machine-readable information from RFID and/or smart chip devices.

10. The method of claims 2, 3, 4, 5, 8 and 15, wherein the mobile or handheld device shall read, store and transmit collected data to a processor in the third-party verification service which shall associate this information with other data, including subscriber identification information, and shall process and store this information in a database until such time the corresponding winning number(s) is/are generated and made available, publicly or otherwise, by the corresponding lottery or gaming authority.

11. The method of claims 2 and 15, wherein the entered, read, processed, deciphered, transmitted, received or stored data is verified for sufficiency and accuracy prior to the completion of one or more comparison, verification and notification service transactions.

12. The method of claims 11 and 15, wherein if there is an error, inconsistency or insufficiency detected, then the subscriber is notified as in claim 3.

13. The method of claims 2, 6 and 15, wherein the mobile or handheld device is enabled by proprietary software to analyze and process at least one photo image of any passive or active readable surface, including a digital readout and a subscriber or (game) retailer identification card in order to facilitate data collection including that of at least one authorized retailer identification/authentication, service initiation, modification and termination, subscriber identification/authentication, play number and associated game information, as well as billing/payment information necessary and sufficient for the initiation, termination and modification of service as well as completion of at least one verification and notification transaction.

14. The method of claims 1-13 and 15, wherein some or all of the functions of the verification service (FIG. 1, module 1B) may be carried out autonomously on-demand-point-of-service at the mobile or handheld device (FIG. 1, module 1A) as enabled by automatic periodic or on-demand transfer of information including that of updated winning number, game identification, subscriber/retailer identification/authentication and billing/payment information, to and from the mobile device such that it is possible to carry out an entire comparison/verification/notification transaction start-to-finish at the mobile device without the need to contact a separate database.

15. A method wherein captured play ticket/receipt and game information, subscriber/purchaser identification and/or payment/billing information including but not limited to password, pass key and biometric information, is used to create a verifiable electronic copy of the subscriber's play ticket/receipt for lottery or gaming.
